(19) United States
(12) Patent Application Publication
(10) Pub. No.: US 2013/0219230 A1
(43) Pub. Date: Aug. 22, 2013

(54) DATA CENTER JOB SCHEDULING

(71) Applicants: Steven F. Best, Groton, MA (US); Janice M. Girouard, Austin, TX (US)

(72) Inventors: Steven F. Best, Groton, MA (US); Janice M. Girouard, Austin, TX (US)

(73) Assignee: INTERNATIONAL BUSINESS MACHINES CORPORATION, Armonk, NY (US)

(21) Appl. No.: 13/399,920

(22) Filed: Feb. 17, 2012

(51) Int. Cl. G06F 9/46; G06F 11/00

(52) U.S. Cl. 714/47.3; 718/102; 714/E11.02

(57) ABSTRACT

A method, computer system, and computer program product for scheduling a computing job at a data center. The method may include receiving a computing job for a data center, determining an operating temperature for a plurality of system components in the data center, assigning a weighting factor for each system component, and scheduling an execution of the computing job using a selected system component, at least in part based upon the weighting factor for that system component where the weighting factor is based upon at least an operating temperature for the system component and an operational lifespan for that system component at that operating temperature.

### BACKGROUND

The present invention relates to the scheduling of computing jobs for a data center, and more specifically, to the scheduling of computing jobs for a data center based at least in part on the operating temperatures of the system components of the data center.

It is becoming increasingly common for companies to employ data centers, rather than individual computer systems, for their data processing needs. Although such data centers can provide flexibility and expanded capacity when needed, a strong incentive exists to efficiently and economically schedule the computing jobs being assigned to the data center. This is true whether the data center exists within a company for internal use, or is owned by a third party.

### BRIEF SUMMARY

According to one embodiment of the present invention, a method of scheduling a computing job may include receiving a computing job for a data center, determining an operating temperature for a plurality of system components in the data center, assigning a weighting factor for each system component, and scheduling an execution of the computing job using a selected system component, at least in part based upon the weighting factor for that system component where the weighting factor is based upon at least an operating temperature for the system component and an operational lifespan for that system component at that operating temperature.

In another embodiment of the present invention, A computer system may include a server, a program including plural instructions stored in a memory storage device and executable by the server to receive a computing job for execution by a data center, determine an operating temperature for each system component in the data center, assign to each system component a weighting factor based upon the operating temperature for that system component and a calculated operational lifespan for that system component at the operating temperature, and schedule an execution of the computing job by a selected system component based at least in part on the weighting factor for that system component.

In yet another embodiment of the present invention, a computer program product for scheduling jobs for a data center may include a plurality of computer-executable instructions stored on a computer-readable medium, where the instructions are executable by a server to receive a computing job for the data center, determine an operating temperature for each system component in the data center, assign a weighting factor for each system component, and schedule an execution of the computing job on a selected system component, at least in part based upon the weighting factor for that system component, where the weighting factor is based upon an operating temperature for the system component and an operational lifespan for that system component at that operating temperature.

### BRIEF DESCRIPTION OF THE SEVERAL VIEWS OF THE DRAWINGS

FIG. 1 is a flowchart depicting a method of scheduling a job for a data center according to an embodiment of the present invention.

FIG. 2 is a pictorial representation of an example of a computer system in which illustrative embodiments may be implemented.

FIG. 3 is a block diagram of an example of a computer in which illustrative embodiments may be implemented.

FIG. 4 depicts a cloud computing node according to an embodiment of the present invention.

FIG. 5 depicts a cloud computing environment according to an embodiment of the present invention.

FIG. 6 depicts abstraction model layers according to an embodiment of the present invention.

### DETAILED DESCRIPTION

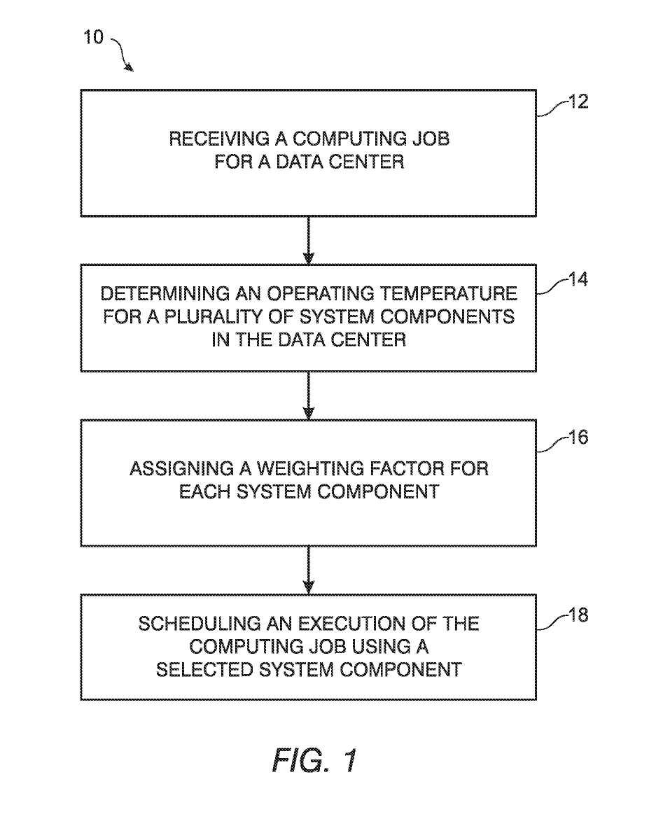

With reference now to flowchart 10 of FIG. 1, one embodiment of the present invention may include a method of scheduling computing jobs for a data center, the method including at least a) receiving a computing job for a data center at 12; b) determining an operating temperature for a plurality of system components in the data center at 14; c) assigning a weighting factor for each system component at 16; and d) scheduling an execution of the computing job using a selected system component at 18, at least in part based upon the weighting factor for that system component where the weighting factor is based upon at least an operating temperature for the system component and an operational lifespan for that system component at that operating temperature.

As will be appreciated by one skilled in the art, aspects of the present invention may be embodied as a method, a computer system, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As set out in flowchart 10 of FIG. 1, one embodiment of the present invention may include a method of scheduling computing jobs for a data center. As used herein, a data center is a facility having a plurality of computer systems and a plurality of associated system components. Such system components may include computer systems, network adapters, network adapters, data storage systems, and telecommunications systems, among others.

The system components within a data center may further include a plurality of system subcomponents, which may include various components for the data center's computer systems, network adapters, data storage systems, or telecommunications systems, among others. For example, the system subcomponents of a computer system may include one or more processors, data storage devices, input devices, and output devices, among others. Each data center typically includes a workload controller that schedules and allocates computing jobs among the computer systems within the data center. The workload controller may include a dedicated processor or computer system, or may correspond to a virtual processor. The workload controller is optionally located physically within a selected data center, or may be remote from the data center and rely upon a network connection to communicate with and control the components of the data center. In one aspect, a given workload controller controls and assigns computing jobs for a single data center; in another aspect a given workload controller may coordinate and assign computing jobs among a plurality of data centers.

A selected data center may be internal to the organization using the data center, or may be operated by a third party that provides access to the data center for its customers. Data centers may be used to run various applications to support the core business of an organization, and/or manipulate, transform, and/or store the operational data of the organization. Typical applications that may be run using a data center include databases, file servers, application servers, middleware, and various others. Alternatively, or in addition, a data center may be used by an organization for storing backup copies of critical data in an off-site and secure location.

The environment within a data center is typically carefully controlled. This is particularly true with respect to the operating temperatures of data center system components. Unfortunately, the heat generated by the equipment within a data center will naturally increase the temperature of the system components. At high temperatures, the electronic components of the data center will malfunction, but even at temperatures well below the point of failure, operating a data center system component at an elevated temperature may reduce the operational lifetime of that component. This loss of operational lifetime may therefore represent a significant component of the cost of carrying out a given computing job.

Therefore, in one embodiment of the present invention, upon receiving a computing job for a data center, the workload controller for that data center determines which of the system components of the data center would be available to process the computing job, and the time windows during which they would be available. The workload controller then determines the operating temperatures for the plurality of the potentially useful system components of the data center using commercially available temperature sensors.

The workload controller then evaluates the plurality of potentially useful system components by assigning a weighting factor to each system component. The weighting factor may incorporate any of a variety of variables reflecting, for example, the reliability of a system component at its determined operating temperature; the lifespan of the system component at its determined operating temperature; the cost of electricity required to complete the computing job using that system component; and the job value of the computing job. The weighting factor typically includes at least some quantification of the costs that would likely result if the received computing job were to be processed by a system component operating at that component's current temperature.

In some instances, the component's current temperature may be an elevated temperature. As used herein, an elevated temperature corresponds to any system component temperature at which the use of that system component would measurably decrease the operational lifetime of that system component. Although an elevated temperature is typically a temperature that is above the recommended operating temperature for a given system component, it should be understood that a particular operating temperature may be within an acceptable range of temperatures as defined by the manufacturer of a given system component, and yet still result in a decrease in operational lifetime of the system component if it is utilized at that temperature.

Where the system component is operating at an elevated temperature, the assigned weighting factor typically would reflect the likely decrease in operational lifetime of the system component associated with operating at an elevated temperature. The weighting factor would therefore typically be selected to decrease the likelihood of that particular system component being assigned a given computing job. Put another way, if a particular system component is operating at an elevated temperature, the weighting factor assigned to that particular system component is given a value that makes that particular system component less desirable (less likely to be chosen) when the workload controller selects the component to perform the desired computing job.

A received computing job may be assigned a job value, where the job value may be an additional factor used in calculating the weighting factor for the computing job. Computing jobs representing critical processes will be given a correspondingly higher job value. Examples of critical processes may include, but are not limited to, computing jobs necessary for LOB (line-of-business) applications. An LOB application, as used herein, is one or more computer applications necessary for engaging in the primary function of an organization or business. Selected examples of critical or LOB applications may include accounting software, supply chain management software, and resource planning applications.

Alternatively, or in addition, a computing job may be assigned a relatively larger job value where the client or customer (whether internal or external) is considered a high-value client or customer. In such cases, a larger job value would emphasize that the computing job be completed promptly, even where such scheduling would result in the computing job being performed by one or more system components operating at an elevated temperature.

Similarly, a computing job having a relatively larger job value may be assigned to a selected system component because that component has a lower probability of component failure during the computing job itself. Where a computing job is assigned a relatively low job value, that computing job may be assigned to a system component with a significant probability of system component failure during the computing job itself, with the knowledge that reassigning the computing job to another system component, even after a delay, is unlikely to have unwanted repercussions. Such low job value jobs may include scheduled backups of archive data, routine database maintenance, and the like.

In summary, where system component may exhibit a lower reliability at the determined operating temperature, that system component may incur an increased penalty in the calculation of the weighting factor assigned to that system component. Additionally, a system component exhibiting a lower reliability at the determined operating temperature may incur a relatively greater penalty in calculating the weighting factor assigned to the system component if the job value of that computing job is relatively higher.

Typically, assigning a computing job to a selected system component includes assigning the computing job at a scheduled time. Again, lower priority computing jobs having lower job values may be assigned for time slots in the future when it is expected that some system components will be free, or be experiencing lower operating temperatures. Contrariwise, where a computing job has a higher job value, it may be assigned an immediate time slot, or experience only a short delay, even if all available system components exhibit elevated operating temperatures.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

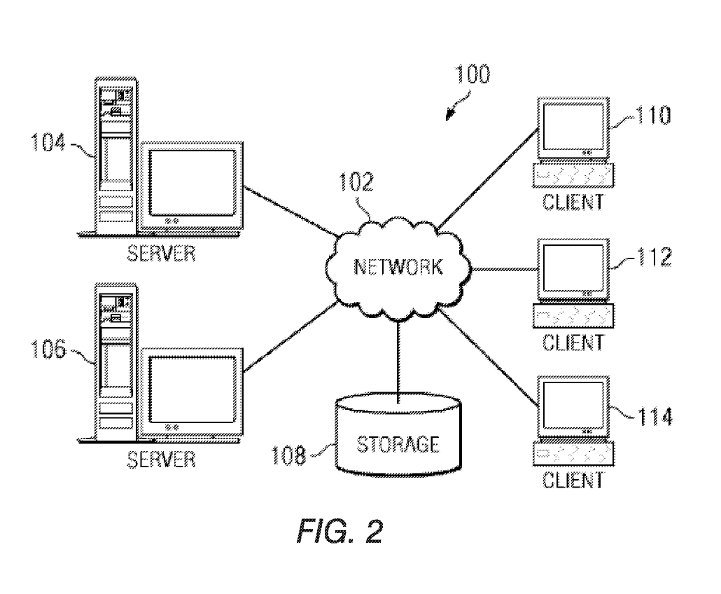

With reference now to the figures and in particular with reference to FIGS. 2-6, exemplary diagrams of data processing environments are provided in which illustrative embodiments may be implemented. It should be appreciated that FIGS. 2-6 are only exemplary and are not intended to assert or imply any limitation with regard to the environments in which different embodiments may be implemented. Many modifications to the depicted environments may be made.

FIG. 2 depicts a pictorial representation of a computer system, indicated generally at 100, and including a network of computers in which illustrative embodiments may be implemented. Computer system 100 may contain a network 102, which is the medium used to provide communications links between various devices and computers connected together within computer system 100. Network 102 may include connections, such as wire, wireless communication links, or fiber optic cables.

In the depicted example, a server 104 and a server 106 may connect to network 102 along with a storage unit 108. In addition, a first client computer 110, a second client computer 112, and a third client computer 114 may connect to network 102. Client computers 110, 112, and 114 may be, for example, personal computers or network computers. In the depicted example, server 104 may provide data, such as boot files, operating system images, and/or software applications to client computers 110, 112, and 114. Client computers 110, 112, and 114 are clients to server 104 in this example. Computer system 100 may include additional servers, clients, and other devices not shown, or may include fewer devices than those shown.

In the depicted example, network 102 may be or may include the Internet. Computer system 100 also may be implemented with a number of different types of networks, such as for example, an intranet, a local area network (LAN), or a wide area network (WAN). FIG. 2 is intended as an example, and not as an architectural limitation for the different illustrative embodiments. For example, embodiments of the present invention are capable of being implemented in conjunction within a cloud computing environment.

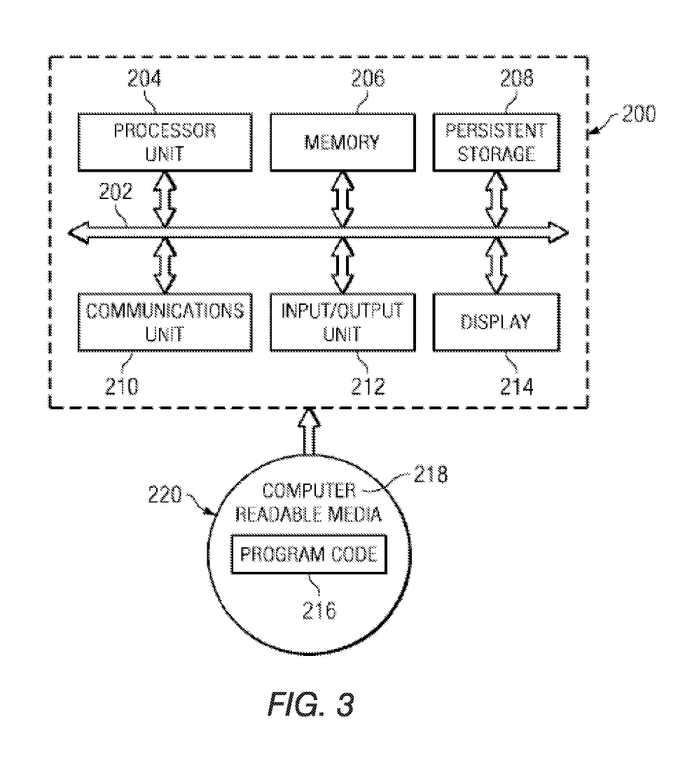

With reference now to FIG. 3, a block diagram of a data processing system is shown in which illustrative embodiments may be implemented. Data processing system 200 is an example of a computer, such as server 104 or client computer 110 in FIG. 2, in which computer-usable program code or instructions implementing the processes may be located for the illustrative embodiments. In this illustrative example, data processing system 200 includes communications fabric 202, which provides communications between a processor unit 204, a memory 206, a persistent storage 208, a communications unit 210, an input/output (I/O) unit 212, and display 214. In other examples, a data processing system may include more or fewer devices.

Processor unit 204 may serve to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. For example, communications unit 210 may be a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 displays information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 may be located in a functional form on a computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 3 can be varied from the illustrative examples shown. As one example, a storage device in data processing system 200 is any hardware apparatus that may store data. Memory 206, persistent storage 208, and computer-readable media 218 are examples of storage devices in tangible forms.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

As is discussed further below, in some examples the present invention may include offloading a business's workload to the cloud, however the cloud is deployed. The business might itself be making its applications available to end users over a network but may not offer any cloud services itself. For example, it might be as simple as hosting an application for taking orders for a flower delivery. This might get overwhelmed during peak times—say Valentines Day—at which time all or a portion of the workload may be offloaded to a replication of the base application in the cloud.

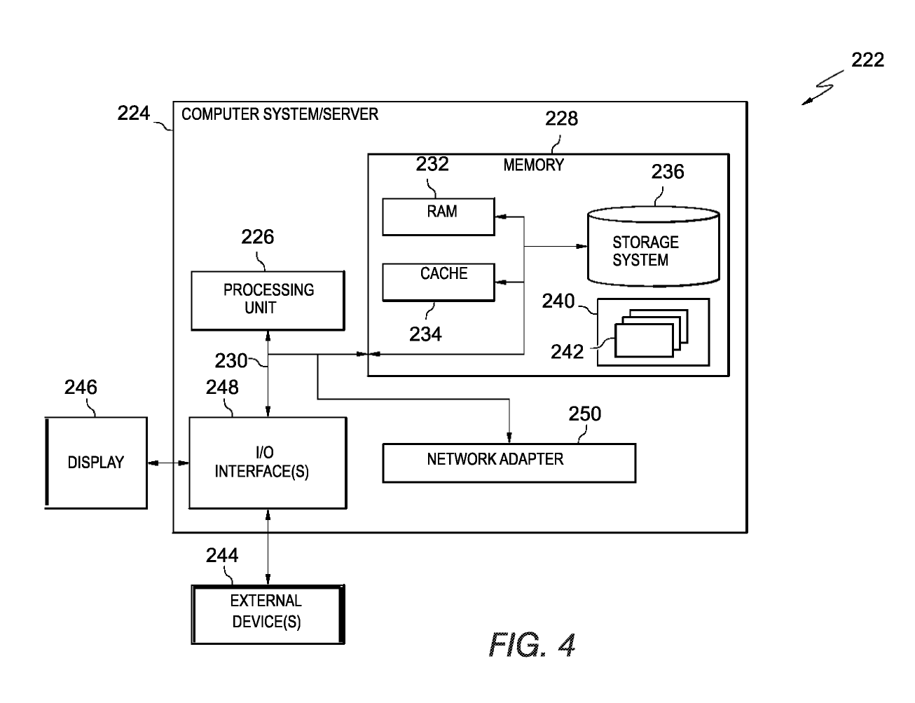

Referring now to FIG. 4, a schematic of an example of a cloud computing node is shown. Cloud computing node 222 is only one example of a suitable cloud computing node and is not intended to suggest any limitation as to the scope of use or functionality of embodiments of the invention described herein. Regardless, cloud computing node 222 is capable of being implemented and/or performing any of the functionality set forth herein above and below.

In cloud computing node 222 there is a computer system/server 224, which is operational with numerous other general purpose or special purpose computing system environments or configurations. Examples of well-known computing systems, environments, and/or configurations that may be suitable for use with computer system/server 224 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 224 may be described in the general context of computer system executable instructions, such as program modules, being executed by a computer system. Generally, program modules may include routines, programs, objects, components, logic, data structures, and so on that perform particular tasks or implement particular abstract data types. Computer system/server 224 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 224 in cloud computing node 222 is shown in the form of a general-purpose computing device. The components of computer system/server 224 may include, but are not limited to, one or more processors or processing units 226, a system memory 228, and a bus 230 that couples various system components including system memory 228 to processor 226.

Bus 230 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 224 typically includes a variety of computer system readable media. Such media may be any available media that is accessible by computer system/server 224, and it includes both volatile and non-volatile media, and removable and non-removable media.

System memory 228 can include computer system readable media in the form of volatile memory, such as random access memory (RAM) 232 and/or cache memory 234. Computer system/server 224 may further include other removable/non-removable, volatile/non-volatile computer system storage media. By way of example only, storage system 236 can be provided for reading from and writing to a non-removable, non-volatile magnetic media (not shown separately and typically called a “hard drive”). Although also not shown separately, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be included in storage system 236. In such instances, each can be connected to bus 230 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system/server 224 may also communicate with one or more external devices 244 such as a keyboard, a pointing device, a display 246, etc.; one or more devices that enable a user to interact with computer system/server 224; and/or any devices (e.g., network card, modem, etc.) that enable computer system/server 224 to communicate with one or more other computing devices. Such communication can occur via Input/Output (PO) interfaces 248. Still yet, computer system/server 224 can communicate with one or more network devices 244 external to cloud computing node 222 over network communication lines of one or more networks such as a local area network (LAN), a general wide area network (WAN), and/or a public network (e.g., the Internet) via a network adapter 250. As depicted, network adapter 250 communicates with the other components of computer system/server 224 via bus 230. It should be understood that although not shown, other hardware and/or software components could be used in conjunction with computer system/server 224. Examples, include, but are not limited to: microcode, device drivers, redundant processing units, external disk drive arrays, RAID systems, tape drives, and data archival storage systems, etc.

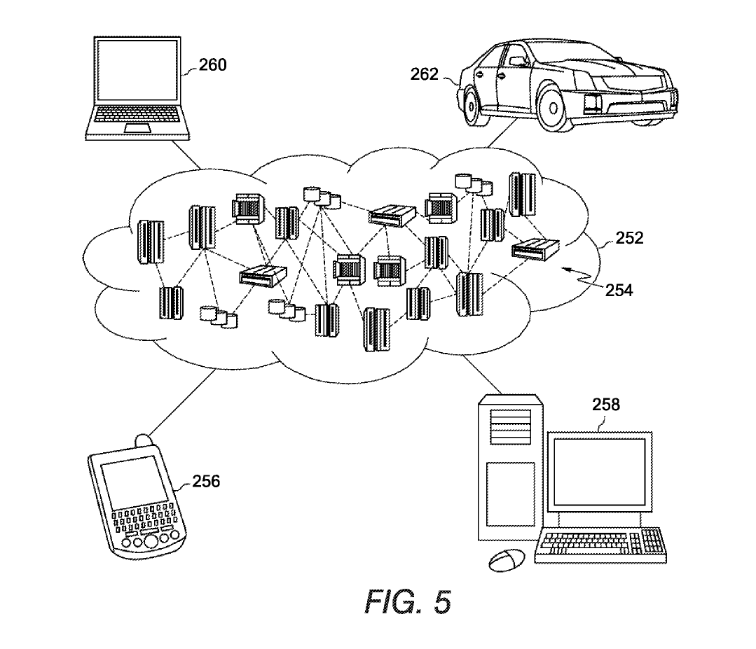

Referring now to FIG. 5, illustrative cloud computing environment 252 is depicted. As shown, cloud computing environment 252 comprises one or more cloud computing nodes 254 with which local computing devices used by cloud consumers, such as, for example, personal digital assistant (PDA) or cellular telephone 256, desktop, personal, or server computer or computer system 258, laptop computer 260, and/or automobile computer system 262 may communicate. Nodes 254 may communicate with one another. They may be grouped (not shown) physically or virtually, in one or more networks, such as Private, Community, Public, or Hybrid clouds as described hereinabove, or a combination thereof. This allows cloud computing environment 252 to offer infrastructure, platforms and/or software as services for which a cloud consumer does not need to maintain resources on a local computing device. It is understood that the types of computing devices 256-262 shown in FIG. 5 are intended to be illustrative only and that computing nodes 254 and cloud computing environment 252 can communicate with any type of computerized device over any type of network and/or network addressable connection (e.g., using a web browser).

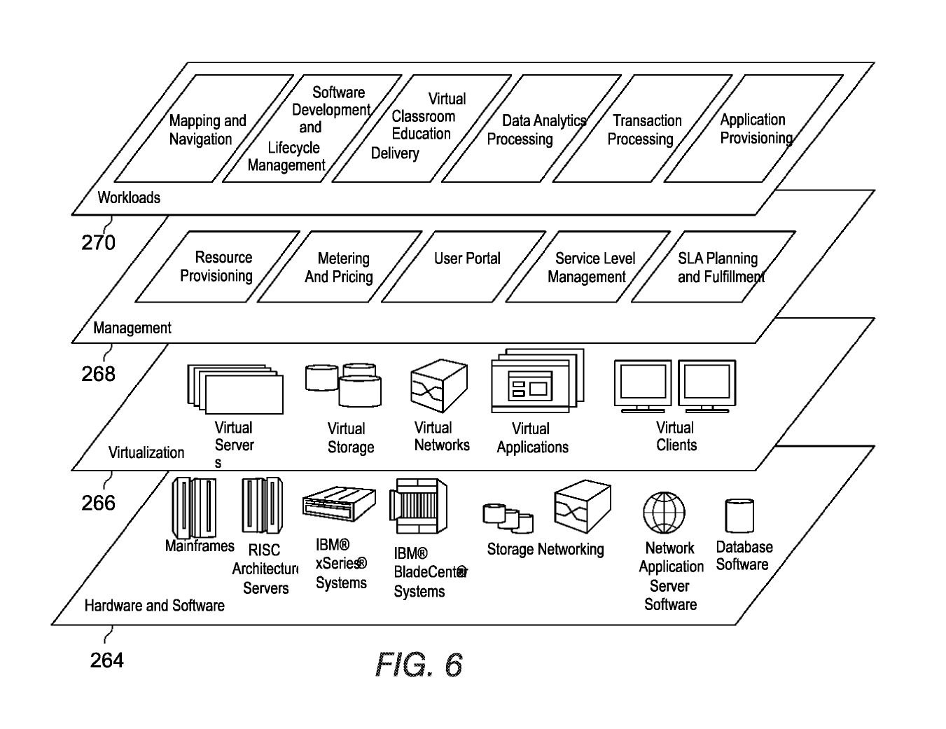

Referring now to FIG. 6, a set of functional abstraction layers provided by cloud computing environment 252 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 264 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 266 provides an abstraction layer from which the following examples of virtual entities may be provided: virtual servers; virtual storage; virtual networks, including virtual private networks; virtual applications and operating systems; and virtual clients.

In one example, management layer 268 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 270 provides examples of functionality for which the cloud computing environment may be utilized. Examples of workloads and functions which may be provided from this layer include: mapping and navigation; software development and lifecycle management; virtual classroom education delivery; data analytics processing; transaction processing; and application provisioning.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the various embodiments of the present invention has been presented for purposes of illustration, but is not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a computing job for a data center;
determining an operating temperature for a plurality of system components in the data center;
assigning a weighting factor for each system component; and
scheduling an execution of the computing job using a selected system component, at least in part based upon the weighting factor for that system component;
where the weighting factor is based upon at least an operating temperature for the system component and an operational lifespan for that system component at that operating temperature.

2. The method of claim 1, where the plurality of system components includes a plurality of system components selected from computer systems, network adapters, telecommunications systems, and data storage systems.

3. The method of claim 1, where the plurality of system components includes a plurality of system subcomponents.

4. The method of claim 3, where the plurality of system subcomponents includes one or more of processors, data storage devices, input devices, and output devices.

5. The method of claim 1, where assigning the weighting factor for each system component includes assigning the weighting factor based on one or more of:
a) a reliability of the system component at the determined operating temperature;
b) a lifespan of the system component at the determined operating temperature;
c) a cost of electricity required to complete the computing job using the system component; and
d) a job value of the computing job.

6. The method of claim 5, where a lower reliability of the system component at the determined operating temperature incurs an increased penalty in the weighting factor assigned to the system component.

7. The method of claim 6, where a lower reliability of the system component at the determined operating temperature incurs a relatively greater penalty in the weighting factor assigned to the system component where the job value of the computing job is relatively higher.

8. The method of claim 6, where assigning the weighting factor for the system component includes assigning the weighting factor based on a reliability of a least reliable system subcomponent of the system component.

9. The method of claim 5, where a decreased lifespan of the system component at the determined operating temperature incurs a relatively greater penalty in the weighting factor assigned to the system component.

10. The method of claim 5, where an increased cost of electricity to complete the computing job using the system component incurs a relatively greater penalty in the weighting factor assigned to the system component.

11. The method of claim 1, where scheduling an execution of the computing job using a selected system component includes selecting a time for the execution of the computing job.

12. The method of claim 1, further comprising determining an operating temperature for a plurality of system components in a plurality of data centers;
assigning a weighting factor for each system component of each data center; and
scheduling an execution of the computing job using a selected system component in a selected data center, at least in part based upon the weighting factor for that system component.

13. A computer system comprising:
a server;
a program including plural instructions stored in a memory storage device and executable by the server to:
receive a computing job for execution by a data center;
determine an operating temperature for each system component in the data center;
assign to each system component a weighting factor based upon the operating temperature for that system component and a calculated operational lifespan for that system component at the operating temperature; and
schedule an execution of the computing job by a selected system component based at least in part on the weighting factor for that system component.

14. The computer system of claim 13, where the program is executable by the server to assign the weighting factor for each system component based on one or more of:
a) a reliability of the system component at the determined operating temperature;
b) a lifespan of the system component at the determined operating temperature;
c) a cost of electricity required to complete the computing job using the system component; and
d) a job value of the computing job.

15. The computer system of claim 14, where the program is executable by the server to:
assign a probability of a failure during the computing job for each system subcomponent of the system component at its determined operating temperature;
calculate an overall probability of a failure of the system component during the computing job based on the assigned probability of failure of each of the system subcomponents; and
assign to each system component a weighting factor based upon the calculated overall probability of a failure of that system component during the computing job.

16. The computer system of claim 14, where the program is executable by the server to:
assign a probability of a failure during the computing job for each system subcomponent of the system component at its determined operating temperature;
assign an overall probability of a failure of the system component during the computing job based on the probability of failure assigned to the system subcomponent having the largest probability of failure during the computing job at its determined temperature.

17. A computer program product for scheduling jobs for a data center, the computer program product including a plurality of computer-executable instructions stored on a computer-readable medium, where the instructions are executable by a server to:
receive a computing job for the data center;
determine an operating temperature for each system component in the data center;
assign a weighting factor for each system component; and
schedule an execution of the computing job on a selected system component, at least in part based upon the weighting factor for that system component; where the weighting factor is based upon an operating temperature for the system component and an operational lifespan for that system component at that operating temperature.

18. The computer program product of claim 17, where the instructions are executable by a server to determine an operating temperature for a plurality of system subcomponents of the system components in the data center.

19. The computer program product of claim 17, where the instructions are executable by a server to determine an operating temperature for each system component in a plurality of data centers, and schedule an execution of the computing job on a selected system component of a selected data center.

20. The computer program product of claim 17, where the instructions are executable by a server to assign the weighting factor for each system component based on one or more of:
a) a reliability of the system component at the determined operating temperature;
b) a lifespan of the system component at the determined operating temperature;
c) a cost of electricity required to complete the computing job using the system component; and
d) a job value of the computing job.
